(19) United States
(12) Patent Application Publication
(10) Pub. No.: US 2015/0014512 A1
(43) Pub. Date: Jan. 15, 2015

(54) AXLE BRAKE BRACKET FOR THIN-WALL AXLE

(71) Applicant: HENDRICKSON USA, L.L.C., Itasca, IL (US)

(72) Inventors: Phillippi R. Pierce, Canton, OH (US); Michael D. Oyster, Stow, OH (US); Dane Gregg, Uniontown, OH (US)

(21) Appl. No.: 14/328,767

(22) Filed: Jul. 11, 2014

Related U.S. Application Data
(60) Provisional application No. 61/845,729, filed on Jul. 12, 2013.

(51) Int. Cl. B60T 1/00; F16M 13/02; B60T 17/00

(52) U.S. Cl. CPC B60T 1/00; B60T 17/00; F16M 13/02
USPC 248/674

(57) ABSTRACT

The invention relates to a brake component mounting bracket for an axle/suspension system that includes a continuous window weld to join the bracket to the axle, which enables the use of a thin-wall axle, desirably reducing the weight and the cost associated with the axle/suspension system. The axle brake bracket secures a cam shaft assembly and a brake assembly to an axle of the axle/suspension system. The bracket comprises an axle portion configured to seat on the axle. At least one window is formed in the axle portion, and the axle portion is rigidly connected to the axle by a continuous weld formed in the window. The axle brake bracket is free of a line weld between the axle portion and the axle.

### CROSS-REFERENCE TO RELATED APPLICATION

This application claims the benefit of U.S. Provisional Patent Application Ser. No. 61/845,729, filed Jul. 12, 2013.

### BACKGROUND OF THE INVENTION

1. Field of the Invention

The present invention relates to the art of brake component mounting for vehicles. More particularly, the invention relates to the art of mounting brake components on an axle/suspension system for heavy-duty vehicles, such as tractor-trailers or semi-trailers. Still more particularly, the invention relates to a brake component mounting bracket for an axle/suspension system that includes a continuous window weld to the axle, which enables the use of a thin-wall axle, desirably reducing the weight and cost associated with the axle/suspension system.

2. Background Art

Heavy-duty vehicles that transport freight, for example, tractor-trailers or semi-trailers and straight trucks, include suspension assemblies that connect the axles of the vehicle to the frame of the vehicle. In some heavy-duty vehicles, the suspension assemblies are connected directly to the primary frame of the vehicle. In other heavy-duty vehicles, the primary frame of the vehicle supports a subframe, and the suspension assemblies connect directly to the subframe. For those heavy-duty vehicles that support a subframe, the subframe can be non-movable or movable, the latter being commonly referred to as a slider box, slider subframe, slider undercarriage, or secondary slider frame. For the purpose of convenience, reference herein will be made to a subframe, with the understanding that such reference is by way of example, and that the present invention applies to heavy-duty vehicle primary frames, movable subframes and non-movable subframes.

In the heavy-duty vehicle art, reference is often made to an axle/suspension system, which typically includes a pair of transversely-spaced suspension assemblies and the axle that the suspension assemblies connect to the vehicle subframe. The axle/suspension system of a heavy-duty vehicle acts to locate or fix the position of the axle and to stabilize the vehicle. More particularly, as the vehicle is traveling over-the-road, its wheels encounter road conditions that impart various forces to the axle on which the wheels are mounted, and in turn, to the suspension assemblies which are connected to and support the axle. These forces consequently act to place or create loads on the axle and the suspension assemblies. In order to minimize the detrimental effect of these forces and resulting loads on the vehicle subframe and other vehicle components as the vehicle is operating, and in turn on any cargo and/or occupants being carried by the vehicle, the axle/suspension system is designed to absorb or dampen at least some of the forces and/or resulting loads.

Two common types of heavy-duty vehicles are known in the art as dry freight vans and refrigerated vans. Dry freight vans include enclosed trailers to keep their freight dry, and are used to transport a wide variety of non-perishable consumer and industrial goods. Refrigerated vans include enclosed trailers with refrigeration systems, and typically are used to transport perishable goods. Such dry freight vans and refrigerated vans have traditionally employed axle/suspension systems that utilize mechanical spring axle/suspension assemblies. These mechanical spring axle/suspension assemblies typically include a pair of leaf spring sets or stacks that are transversely spaced and are connected to the axle. Each leaf spring stack is engineered to carry the rated vertical load of its respective axle. Ordinarily, a trailer of a dry freight or refrigerated van employs one or more mechanical spring axle/suspension systems at the rear of the trailer, that is, a front axle/suspension system and a rear axle/suspension system, which is a configuration that is collectively referred to in the art as a trailer tandem axle/suspension system. As is known to those skilled in the art, the front end of the trailer is supported by a separate axle/suspension system of the tractor. For the purpose of convenience, reference herein shall be made to a spring axle/suspension system with the understanding that such reference is to a trailer tandem mechanical spring axle/suspension system.

In most axle/suspension systems, it is necessary to mount components of the vehicle braking system to one or more locations on the axle/suspension system. More particularly, the axle of the axle/suspension system includes a central tube, and an axle spindle is integrally connected by any suitable means, such as welding, to each end of the central tube. A wheel end assembly is rotatably mounted, as known in the art, on each axle spindle. A brake drum is mounted on the wheel end assembly, and as will be described in greater detail below, components of the vehicle braking system are actuated to apply friction to the brake drum in order to slow or stop the vehicle. Inasmuch as each end of the axle and its associated spindle, wheel end assembly and brake drum is generally identical to the other, only one axle end and its associated spindle, wheel end assembly and brake drum will be described herein.

As known in the art, when the operator of a heavy-duty vehicle applies the vehicle brakes to slow or stop the vehicle, compressed air is communicated from an air supply source, such as a compressor and/or air tank, through air lines to a brake chamber or brake air chamber. The brake chamber converts the air pressure into mechanical force and moves a pushrod. The pushrod in turn moves a slack adjuster, which is connected to one end of a cam shaft of a cam shaft assembly. The cam shaft assembly enables smooth, stable rotation of the cam shaft upon movement of the slack adjuster. An S-cam is mounted on the end of the cam shaft that is opposite the slack adjuster, so that rotation or turning of the cam shaft by the slack adjuster causes rotation of the S-cam. Rotation of the S-cam forces brake linings or pads to make contact with the brake drum to create friction and thus slow or stop the vehicle. In order for the brake chamber, pushrod, slack adjuster, and cam shaft to operate properly, the brake chamber and the cam shaft assembly must be mounted on a generally stable structural member near the brake drum. More particularly, mounting of the brake chamber and the cam shaft assembly on a generally stable structural member near the brake drum is necessary so that proper alignment of the brake chamber, pushrod, slack adjuster, and cam shaft is maintained, which is important for proper actuation and performance of the brake system.

In spring axle/suspension systems of the prior art, the brake chamber has been mounted on a brake chamber mounting bracket, and the cam shaft assembly has been mounted on a cam shaft assembly mounting bracket, which is also referred to in the art as an S-cam bearing bracket. Because it is not feasible to mount the brake chamber mounting bracket and/or the cam shaft assembly mounting bracket directly on or to a leaf spring, these brackets have been mounted on the axle in the prior art. More particularly, the leaf spring must flex to dampen forces and thus does not provide a stable structural mounting surface. In addition, because a leaf spring is formed with a metallurgical structure that enables it to flex while withstanding significant stress, attempting to mount such brackets directly on or to the leaf spring may significantly decrease the ability of the leaf spring to withstand stress. As a result, the axle central tube, which is a generally stable structural member that is relatively near the brake drum, has been used as a mounting location for the brake chamber mounting bracket and the cam shaft assembly mounting bracket.

More particularly, the brake chamber mounting bracket has been rigidly connected to a front portion of the axle central tube just inboardly of a respective leaf spring stack by line welding, which is welding of the base of the bracket to the axle central tube with a line weld in which the weld begins at one point and ends at a separate point. Similarly, the cam shaft assembly mounting bracket has been rigidly connected to a rear portion of the axle central tube just inboardly of a respective leaf spring stack by a line weld. Such prior art mounting of the brake chamber to a bracket that includes a line weld to the axle central tube, and mounting of the cam shaft assembly to a bracket that is also in turn line welded to the axle central tube, has provided a generally stable structural mounting configuration that enables sufficient operation of the brake system components. However, this configuration has certain disadvantages, including a susceptibility to stress.

For example, axles typically are hollow, which desirably reduces the amount of material used to manufacture an axle, thereby decreasing manufacturing costs, and also reduces axle weight, thereby reducing vehicle fuel consumption and costs associated with operation of the vehicle. As a result, it is desirable to use an axle with the thinnest possible wall to optimize the material and weight savings.

However, line welds include a starting point and an end point that create an area that is susceptible to stress, known as stress risers. As a result, the starting point and end point of the line weld include undesirable areas of stress risers. The use of line welds to rigidly connect a brake chamber mounting bracket and a cam shaft assembly mounting bracket to the axle undesirably requires increasing the wall thickness of the axle as a result of the stress risers, as will be described below.

More particularly, it is known in the art that the portion of the axle central tube which is between the leaf spring stacks is a high-stress area, due to the transmission of forces and the creation of resulting loads across the axle between the leaf spring stacks during vehicle operation. When a component is line welded to a hollow axle central tube, an area on the axle wall adjacent the weld is created that is generally more susceptible to stress than a non-welded area and other types of welded areas. As a result, when forces and resulting loads act upon the axle, an area with a line weld along the axle central tube is generally more susceptible to failure from such forces and/or loads than a non-welded area. In order to compensate for the increased susceptibility to stress that is caused by line welds, the wall thickness of the axle typically is increased, which undesirably increases the amount of material used to manufacture the axle, and also undesirably increases the weight of the axle. Thus, in the prior art, the use of a brake chamber mounting bracket and a cam shaft assembly mounting bracket that are each line welded to the axle central tube has required the use of a relatively thick-walled axle, such as one having a wall thickness of about one-half of an inch (0.500 inches) or greater. Such a thick-walled axle undesirably increases the weight and the cost associated with the axle/suspension system.

Alternatively in the prior art, air-ride axle/suspension systems, which are different in structure and operation from spring axle/suspension systems, have employed mounting structures in which a line weld of the brake chamber mounting bracket and/or the cam shaft assembly mounting bracket to the axle central tube was eliminated. However, such mounting structures cannot be employed in a spring axle/suspension system because air-ride axle/suspension systems are different in structure and operation from spring axle/suspension systems. For example, air-ride axle/suspension systems include a pair of transversely-spaced leading or trailing arm box-type beams, in which a first end of each box-type beam is connected to the vehicle subframe, and a second or opposite end of each box-type beam is connected to the axle. In the air-ride axle/suspension system prior art, welding of the brake chamber mounting bracket and/or the cam shaft assembly mounting bracket to the axle central tube was eliminated by mounting the brake chamber and the cam shaft assembly mounting bracket directly on the box-type beam.

Due to the different structural requirements and operation of box-type beams of an air-ride axle/suspension system and leaf springs of a spring axle/suspension system, it is not feasible to connect the brake chamber mounting bracket and the bearing bracket directly to a leaf spring. More particularly, air-ride axle/suspension systems include air springs to dampen certain forces and thus cushion the vehicle ride. As a result, each box-type beam typically is a rigid beam that is fabricated or cast and typically includes one or more sidewalls, an upper wall, and a bottom wall, and a rear wall, and is rigidly connected to the axle. As described above, in order for the brake chamber, pushrod, slack adjuster and cam shaft to operate properly, the brake chamber and the cam shaft assembly must be mounted on a generally stable structural member near the brake drum. In an air-ride axle/suspension system, the generally rigid nature of each box-type beam and its generally rigid connection to the axle enables the box beam to be used as a stable structural mounting surface for components such as brake chamber mounting bracket and the cam shaft assembly mounting bracket.

In addition, since each air-ride axle/suspension system box-type beam includes one or more sidewalls, an upper wall, and a bottom wall, sufficient structural surface area is provided to enable the mounting of components such as the brake chamber mounting bracket and the cam shaft assembly mounting bracket to be connected to the box-type beam.

In contrast, spring axle/suspension systems do not employ air springs, instead relying on the leaf springs to flex and thus dampen forces. Because the leaf springs flex during vehicle operation, they do not provide a sufficient stable structural mounting surface to enable the mounting of components such as the brake chamber mounting bracket and the cam shaft assembly mounting bracket. In addition, because leaf springs are formed with a metallurgical structure that enables them to flex while withstanding significant stress, it is undesirable to attempt to mount such brackets on the leaf springs, as such mounting may significantly decrease the ability of the leaf springs to withstand stress.

As a result, a need has existed in the art for an axle/suspension system that overcomes the disadvantages of prior art systems by providing a structure that enables a brake chamber and a cam shaft assembly to be rigidly mounted on or adjacent to a thin-wall axle without the use of line welds, which in turn desirably reduces the weight and cost associated with the axle/suspension system. The axle brake component mounting bracket for an axle/suspension system of the present invention satisfies this need.

### SUMMARY OF THE INVENTION

An objective of the present invention is to provide an axle brake bracket for an axle/suspension system that eliminates the use of line welds of the prior art, thereby decreasing stress risers.

Another objective of the present invention is to provide an axle brake bracket for an axle/suspension system that enables the use of a thin-wall axle, thereby facilitating reduced weight and reduced operating costs for the axle/suspension system.

These objectives and advantages are obtained by an axle brake bracket for an axle/suspension system, the bracket securing a cam shaft assembly and a brake assembly to an axle of the axle/suspension system, the bracket comprising an axle portion configured to seat on the axle. At least one window is formed in the axle portion, and the axle portion is rigidly connected to the axle by a continuous weld formed in the at least one window. The axle brake bracket is free of a line weld between the axle portion and the axle.

### BRIEF DESCRIPTION OF THE SEVERAL VIEWS OF THE DRAWINGS

The preferred embodiments of the present invention, illustrative of the best modes in which applicants have contemplated applying the principles, are set forth in the following description and are shown in the drawings, and are particularly and distinctly pointed out and set forth in the appended claims.

FIG. 1 is a passenger side front perspective view of a portion of a prior art trailer tandem mechanical spring axle/suspension assembly, shown mounted on a vehicle, with portions shown in ghost;

FIG. 2 is a passenger side rear perspective view of the prior art trailer tandem mechanical spring axle/suspension assembly shown in FIG. 1;

FIG. 3 is a top perspective view of a portion of the prior art mechanical spring axle/suspension assembly shown in FIG. 1;

FIG. 4 is a bottom perspective view of the prior art axle suspension system shown in FIG. 3;

FIG. 5 is a top rear perspective view of a prior art air-ride axle/suspension system, with hidden components represented by broken lines;

FIG. 6 is a side elevational view of selected components of the prior art air-ride axle/suspension system shown in FIG. 5, partially in section, with a box-type beam and hidden brake system components represented by broken lines;

FIG. 7 is a top front perspective view of a thin-wall axle including a first exemplary embodiment of the axle brake bracket of the present invention mounted thereon;

FIG. 8 is a rear perspective view of thin-wall axle shown in FIG. 7;

FIG. 9 is a bottom rear perspective view of the first exemplary embodiment of axle brake bracket of the present invention shown in FIGS. 7-8;

FIG. 10 is a bottom front perspective view of the axle brake bracket shown in FIG. 9;

FIG. 11 is a bottom rear perspective view of a second exemplary embodiment of the axle brake bracket of the present invention;

FIG. 12 is bottom front perspective view of the axle brake bracket shown in FIG. 11;

FIG. 13 is a bottom front perspective view of a third exemplary embodiment of the axle brake bracket of the present invention;

FIG. 14 is a bottom rear perspective view of the axle brake bracket shown in FIG. 13;

FIG. 15 is a bottom front perspective view of a fourth exemplary embodiment of the axle brake bracket of the present invention; and

FIG. 16 is a bottom rear perspective view of the axle brake bracket shown in FIG. 15.

Similar numerals refer to similar parts throughout the drawings.

### DESCRIPTION OF THE PREFERRED EMBODIMENT

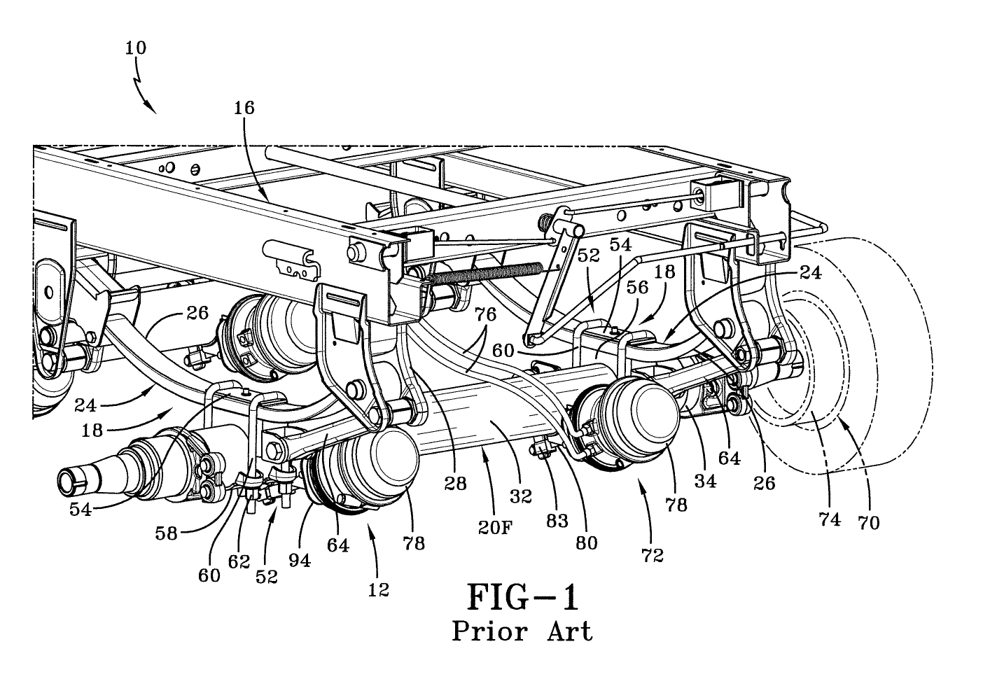

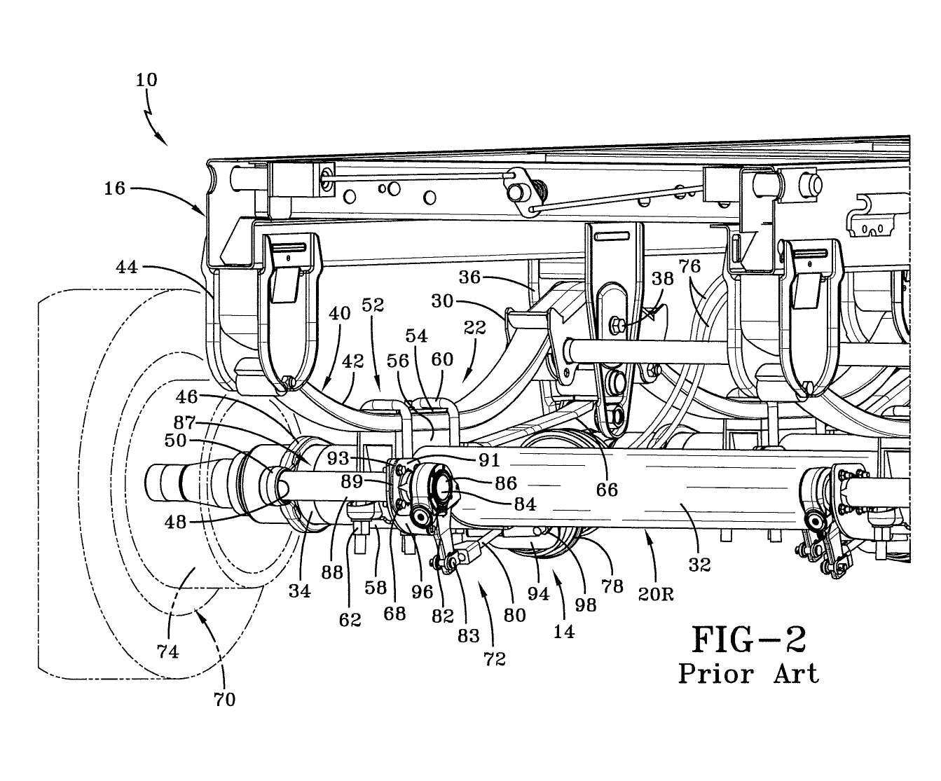

In order to better understand the axle brake bracket for thin-wall axles of the present invention and the environment in which it operates, a prior art spring axle/suspension system is indicated generally at 10 and is shown in FIGS. 1 and 2. Prior art spring axle/suspension system 10 is a tandem axle/suspension system, utilizing a front axle/suspension system 12 and a rear axle/suspension system 14, each of which is connected to and depends from a vehicle frame or subframe 16, as known in the art. As mentioned above, in some heavy-duty vehicles, the axle/suspension systems are connected directly to the primary frame of the vehicle, while in other heavy-duty vehicles, the primary frame of the vehicle supports a movable or non-movable subframe, and the axle/suspension systems connect directly to the subframe. For the purpose of convenience, reference herein will be made to subframe 16, with the understanding that such reference is by way of example, and that the present invention applies to heavy-duty vehicle primary frames, movable subframes and non-movable subframes.

Front axle/suspension system 12 includes a pair of transversely-spaced, longitudinally-extending mechanical spring suspension assemblies 18, which connect to a front axle 20F. Similarly, rear axle/suspension system 14 includes a pair of transversely-spaced, longitudinally-extending mechanical spring suspension assemblies 22 (only one shown), which connect to a rear axle 20R. Inasmuch as each one of the pair of front mechanical spring suspension assemblies 18 is identical to the other, and each one of the pair of rear mechanical spring suspension assemblies 22 is identical to the other, only one of each will be described herein. Front mechanical spring suspension assembly 18 includes a leaf spring set or stack 24, which in turn includes one or more leaf springs 26. Rear mechanical spring suspension assembly 22 includes a leaf spring set or stack 40, which in turn includes one or more leaf springs 42.

In front mechanical spring suspension assembly 18, front leaf spring 26 extends longitudinally between a front hanger 28, which is mounted on and depends from subframe 16 in a manner known to those skilled in the art, and an equalizer or rocker 30 (FIG. 2). Equalizer 30 in turn is pivotally connected to a center hanger 36 by a pin and bushing assembly 38, and the center hanger is mounted on and depends from subframe 16, as known in the art. In rear mechanical spring suspension assembly 22, rear leaf spring 42 extends longitudinally between equalizer 30 and a rear hanger 44, which is mounted on and depends from subframe 16 in a manner known to those skilled in the art. Also as known in the art, equalizer 30 provides a connection between front and rear suspension assemblies 18, 22, respectively, and pivots in order to attempt to balance the loads between front and rear axles 20F, 20R.

Front leaf spring 26 is clamped to front axle 20F by a clamp assembly 52. More particularly, clamp assembly 52 includes a top block 54 that is disposed on the upper surface of leaf spring 26 at about the longitudinal midpoint of the top spring, a top axle seat 56 that extends between the bottom of the leaf spring and the upper portion of front axle 20F in vertical alignment with the top block, and a bottom axle seat 58, which is a essentially a curved plate disposed on the lower portion of the front axle in vertical alignment with the top block and the top axle seat. Clamp assembly 52 also includes a pair of U-bolts 60, each one of which engages top block 54 and extends through a pair of openings (not shown) formed in bottom axle seat 58. In this manner, top block 54, front leaf spring 26, top axle seat 56, axle 20F, and bottom axle seat 58 are rigidly clamped together when nuts 62 are tightened onto threaded ends of U-bolts 60. It is understood that rear leaf spring 42 is clamped to rear axle 20R by clamp assembly 52 in a manner similar to that as described for front leaf spring 26.

In order to control fore-aft movement of front axle 20F, a front radius rod 64 is pivotally connected to and extends between front hanger 28 and front axle top axle seat 56. Likewise, to control fore-aft movement of rear axle 20R, a rear radius rod 66 is pivotally connected to and extends between center hanger 36 and rear axle top axle seat 56.

Inasmuch as each one of front axle 20F and rear axle 20R is identical to the other, only one axle will be described herein. Axle 20F includes a central tube 32, and an axle spindle 34 is integrally connected by any suitable means, such as welding, to each end of the central tube. A wheel end assembly 70 is rotatably mounted on each axle spindle 34, as known in the art. A brake system 72 includes a brake drum 74 that is mounted on wheel end assembly 70. Inasmuch as each end of axle 20F and its associated spindle 32, wheel end assembly 70, brake drum 74, and associated components of brake system 72 are generally identical to the other, only one end of the axle and its associated spindle, wheel end assembly, brake drum, and associated components of the brake system will be described herein.

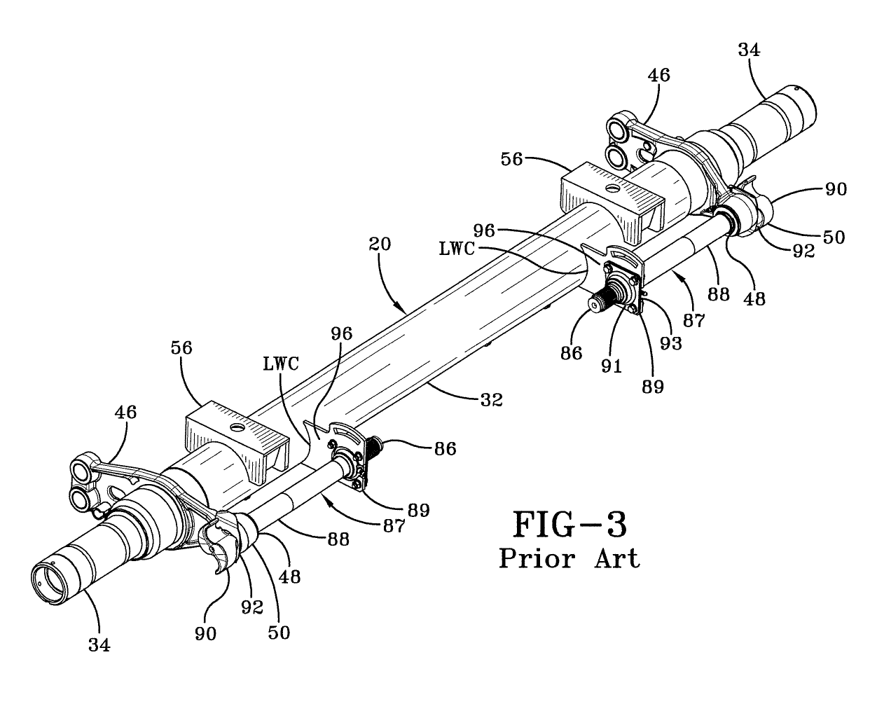

In order to slow or stop the vehicle, compressed air is communicated through air lines 76 to a brake chamber 78, which converts the air pressure into mechanical force and moves a pushrod 80 in a longitudinal manner relative to the brake chamber. Pushrod 80 is pivotally connected to slack adjuster 82 by a pin-and-link assembly or clevis 83, which enables the slack adjuster to convert the longitudinal movement of the pushrod to rotational movement. Slack adjuster 82 in turn is connected to an inboard end 84 of cam shaft 86 of a cam shaft assembly 87. As known in the art, cam shaft inboard end 84 is splined and meshingly engages a corresponding splined interior surface (not shown) of slack adjuster 82. An S-cam 90 (FIG. 3) of cam shaft assembly 87 is mounted on an outboard end 92 of cam shaft 86, whereby rotation of the cam shaft by slack adjuster 82 causes rotation of the S-cam. Rotation of S-cam 90 forces brake linings or pads (not shown) to make contact with an inner surface of brake drum 74 to create friction and thus slow or stop the vehicle.

Components of cam shaft assembly 87 enable smooth, stable rotation of cam shaft 86 upon movement of slack adjuster 82. More particularly, cam shaft 86 is rotatably mounted in a cam tube 88 by bushings (not shown), as known in the art, and extends through the tube. In this manner, inboard end 84 of a cam shaft 86 is exposed in order to engage slack adjuster 82, and outboard end 92 (FIG. 3) of the cam shaft is also exposed in order to enable S-cam 90 to engage brake linings or pads. In order to secure the position of cam shaft 86 parallel to axle 20F, and to ensure that only the cam shaft rotates, rather than cam tube 88, a cam tube bracket 89 receives and retains the inboard end of the cam tube. An exemplary cam tube bracket 89 includes an inboard plate 91 and an outboard plate 93, each one of which is formed with a plurality of tabs (not shown) that secure the cam tube, as more fully described in U.S. Pat. No. 7,537,224, which is assigned to the same assignee as the present invention, Hendrickson USA, L.L.C. To support the outboard end of cam tube 88 and thus outboard end 92 of cam shaft 86, a brake spider 46 is immovably mounted on axle 20F, such as by welding, outboardly of spring stack 24. The outboard end of cam tube 88 is mounted in a bore 48 formed in a collar 50 of the spider, as known in the art.

Alignment of brake chamber 78, pushrod 80, slack adjuster 82, and cam shaft 86 is important for proper actuation and performance of brake system 72, thereby necessitating the mounting of the brake chamber and cam shaft assembly 87 on a stable structural member near brake drum 74. In the prior art, such mounting was achieved by mounting brake chamber 78 on a brake chamber mounting bracket 94, and by mounting cam tube bracket 89 of cam shaft assembly 87 on a cam shaft assembly mounting bracket 96, which is also referred to in the art as an S-cam bearing bracket.

More particularly, brake chamber 78 is mounted on brake chamber mounting bracket 94 by mechanical fasteners, such as bolts 98. Brake chamber mounting bracket 94 in turn is rigidly connected to axle 20F by line welding the bracket to a front portion of axle central tube 32 inboardly of leaf spring 26, as will be described below. Similarly, cam tube bracket 89 is mounted on cam shaft assembly mounting bracket 96 by mechanical fasteners, such as bolts 68. Cam shaft assembly mounting bracket 96 in turn is rigidly connected to axle 20F by line welding the bracket to a rear portion of axle central tube 32 inboardly of leaf spring 26 as will be described below.

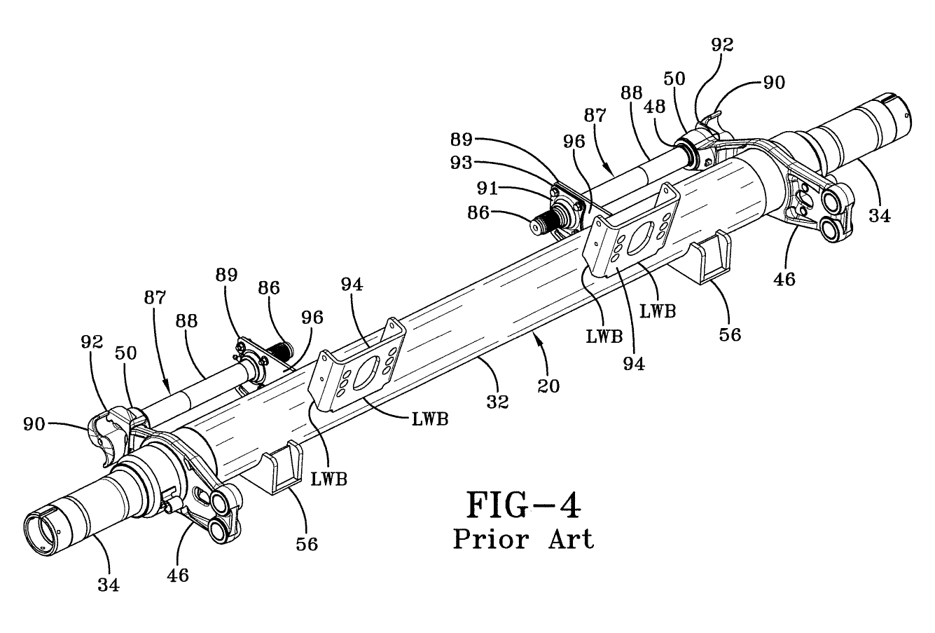

As is more clearly shown in FIGS. 3-4, prior art brake chamber mounting bracket 94 and prior art cam shaft assembly mounting bracket 96 are rigidly connected to axle 20. Prior art brake chamber mounting bracket 94 and prior art cam shaft assembly mounting bracket 96 are separate brackets that are separately line welded to axle 20. A line weld, as known in the art, is a discrete weld that starts at one point and ends at a separate point. The starting point and the end point of the line weld create an area that is susceptible to stress, known as stress risers. As a result, the starting point and end point of the line weld include undesirable areas of stress risers.

More particularly, brake chamber mounting bracket 94 is line welded at a junction LWB and prior art cam shaft assembly mounting bracket 96 is line welded at junction LWC. When prior art brake chamber mounting bracket 94 and prior art cam shaft assembly mounting bracket 96 are line welded to central tube 34, the area adjacent to the central tube is generally more susceptible to stress as a result of the increased stress risers due to the line weld. Additionally, because the portion of axle central tube 32 that is between leaf springs 26 is known to be a high-stress area due to the transmission of forces and resulting loads across axle 20F during vehicle operation, the line weld area of the axle central tube is generally more susceptible to possible failure from such forces and/or loads. In order to compensate for the increased susceptibility to stress that is caused by line welding brake chamber mounting bracket 94 and cam shaft assembly mounting bracket 96 to axle 20F, the wall thickness of axle 20F, 20R typically is increased. Such an increase in wall thickness undesirably increases the amount of material used to manufacture axle 20F, undesirably increasing the weight of the axle, and in turn undesirably increasing manufacturing costs and fuel consumption during vehicle operation.

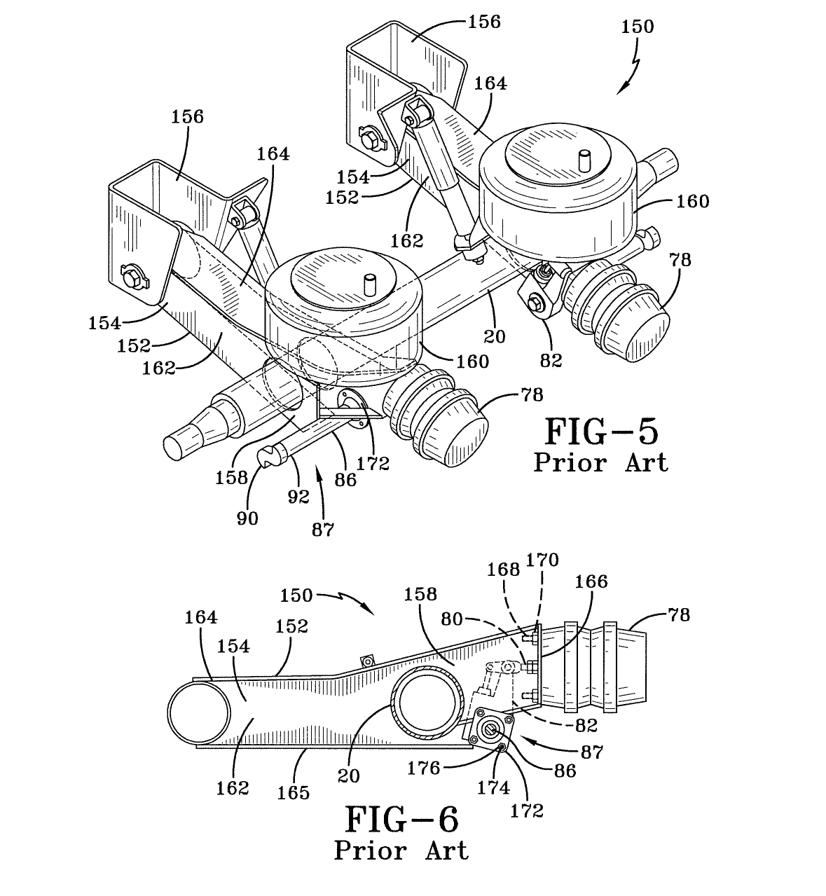

Alternatively in the prior art, air-ride axle/suspension systems, such as an exemplary air-ride axle/suspension system indicated generally at 150 and shown in FIGS. 5 and 6, have employed structures in which welding of the brake chamber mounting bracket and/or the s-cam bearing bracket to the axle central tube was eliminated, which was enabled by the structural differences between certain air-ride axle/suspension systems and spring axle/suspension systems 10. More particularly, and as described in greater detail in U.S. Pat. No. 5,366,237, air-ride axle/suspension system 150 includes a pair of transversely-spaced leading or trailing arm box-type beams 152. A first end 154 of each box-type beam 152 is pivotally connected to a hanger 156, which in turn is rigidly connected to vehicle subframe 16 (FIG. 1), and a second end 158 of each box-type beam is rigidly connected to axle 20. Air-ride axle/suspension system 150 includes air springs 160 to cushion the vehicle ride and provide some damping characteristics, enabling each box-type beam 152 to be a rigid beam that is fabricated or cast, and which includes one or more sidewalls 162, an upper wall 164, a bottom wall 165 and a rear wall 166.

In air-ride axle/suspension system 150, brake chamber 78 is mounted directly on box-type beam rear wall 166 by brake chamber bolts 168 and nuts 170. A cam shaft assembly mounting bracket 172 is connected to a selected one of beam sidewalls 162 by bolts 174 and nuts 176, and supports cam shaft assembly 87, which is mounted on the bracket. With this structure, brake chamber 78 moves pushrod 80 upon actuation. Pushrod 80 in turn moves slack adjuster 82, as enabled by the pivotal connection of the pushrod to the slack adjuster. Slack adjuster 82 is operatively connected to cam shaft 86 of cam shaft assembly 87, enabling rotation of the cam shaft upon movement of the slack adjuster. Rotation of cam shaft 86 by slack adjuster 82 causes rotation of S-cam 90, which is mounted on outboard end 92 of the cam shaft. Rotation of S-cam 90 forces brake linings or pads (not shown) to make contact with an inner surface of brake drum 74 (FIG. 1) to create friction and thus slow or stop the vehicle. It is understood that, while cam shaft assembly 87 is shown in FIGS. 5 and 6 without cam tube 88, the cam shaft assembly may employ the cam tube and its associated components, in a manner similar to that as described above.

Alignment of brake chamber 78, pushrod 80, slack adjuster 82, and cam shaft 86 is important for proper actuation and performance of brake system 72, thereby necessitating the mounting of the brake chamber and cam shaft assembly 87 on a stable structural member near brake drum 74. In air-ride axle/suspension system 150, the rigid nature of each box-type beam 152 and its rigid connection to axle 20 enables the box beam to be used as a stable structural mounting surface for brake chamber 78 and cam shaft assembly mounting bracket 172. In addition, since each air-ride axle/suspension system box-type beam 152 includes sidewalls 162, upper wall 164, bottom wall 165, and rear wall 166, sufficient structural surface area is provided to enable the mounting of brake chamber 78 and cam shaft assembly mounting bracket 172 to the box-type beam.

In contrast, as shown in FIGS. 1 and 2, spring axle/suspension system 10 does not employ air springs 160 (FIG. 5), instead relying on leaf springs 26, 42 to flex and thus dampen forces. Because leaf springs 26, 42 flex during vehicle operation, they do not provide a sufficient stable structural mounting surface to enable the mounting of brake chamber 78, brake chamber mounting bracket 94, and/or cam shaft assembly mounting bracket 96, 172. In addition, because leaf springs 26, 42 are formed with a metallurgical structure that enables them to flex while withstanding significant stress, it is undesirable to attempt to mount brake chamber 78, brake chamber mounting bracket 94, and/or cam shaft assembly mounting bracket 96, 172 on the leaf springs, as such mounting may significantly decrease the ability of the leaf springs to withstand stress.

Therefore, there is a need in the art for an axle/suspension system that overcomes the disadvantages of prior art systems by providing an axle brake bracket that enables a brake chamber and a cam shaft assembly to be rigidly connected to the vehicle axle facilitating a thin-wall axle to be used. The axle brake bracket for an axle/suspension system of the present invention satisfies this need, as will now be described.

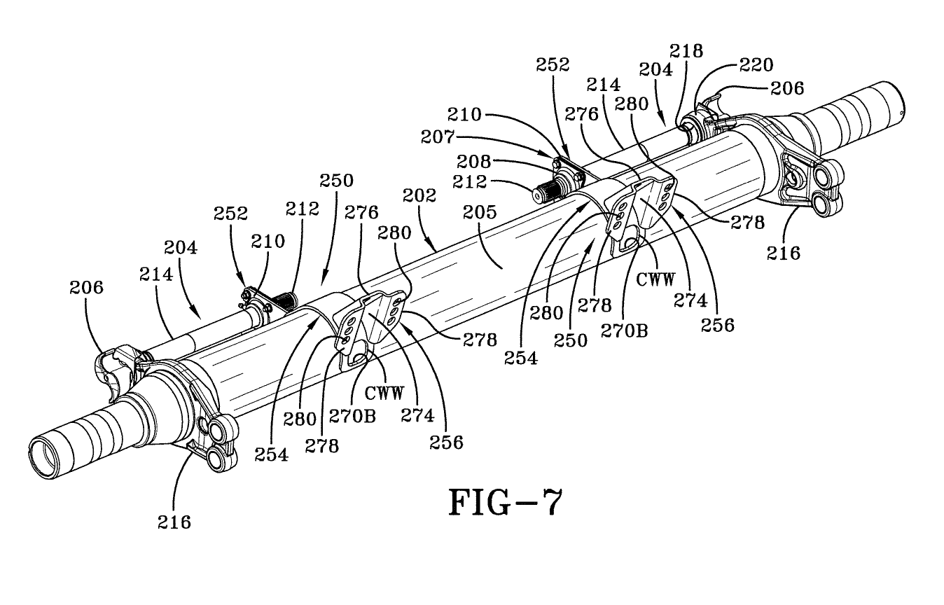

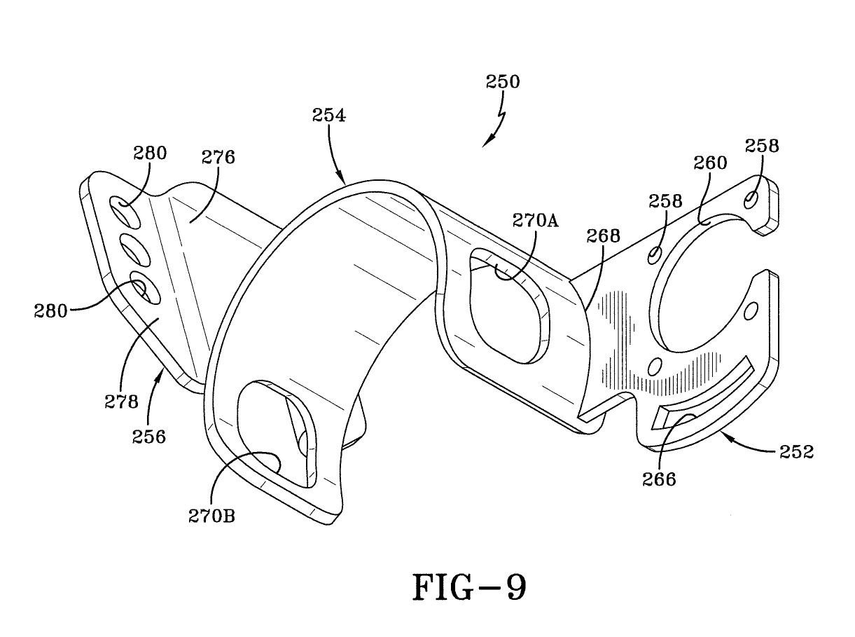

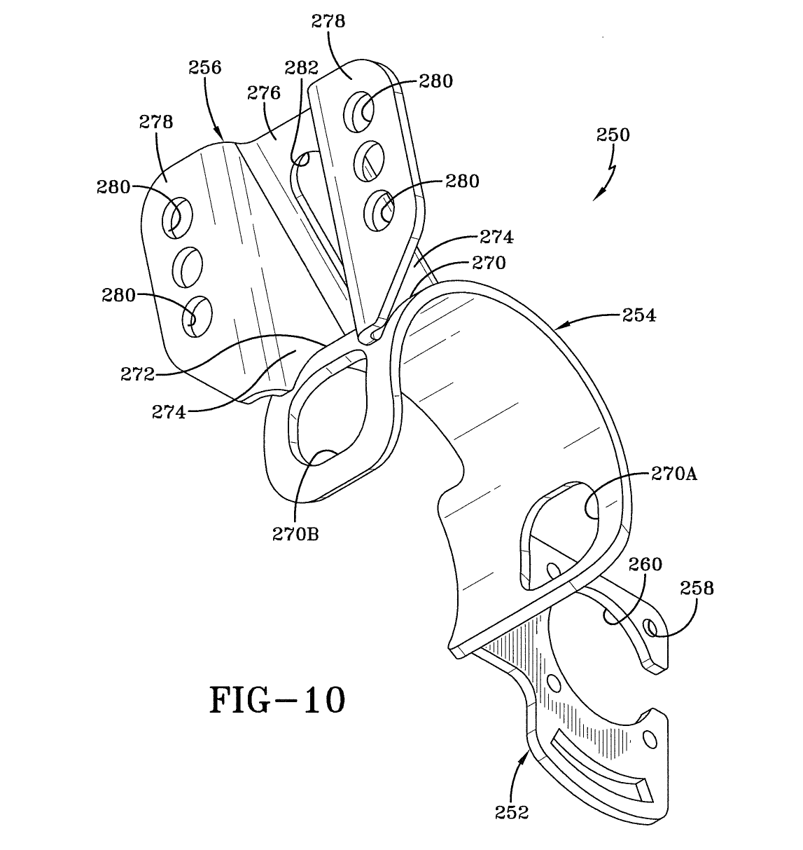

Turning to FIGS. 7-10, first embodiment axle brake bracket 250 is shown connected to thin-wall axle 202. Although a pair of axle brake brackets 250 is shown, they are identical in structure and function so only one will be discussed. Components of cam shaft assembly 204 facilitate smooth stable rotation of cam shaft 212 upon movement of slack adjuster (not shown). More particularly, cam shaft 212 is rotatably mounted in a cam tube 214 by bushings (not shown) and extends through the tube. In this manner, S-cam 206 is exposed to engage brake linings or pads (not shown). In order to ensure that cam shaft 212 is parallel to axle 202, and to ensure that only the cam shaft rotates, rather than cam tube 214, a cam tube bracket 207 receives and retains the inboard end of the cam tube. Cam tube bracket 207 includes an inboard plate 208 and an outboard plate 210, each one of which is formed with a plurality of tabs (not shown) that secure cam tube 214. To support the outboard end of cam tube 214, a brake spider 216 is immovably mounted on axle 202, such as by welding. The outboard end of cam tube 214 is mounted in a bore 218 formed in a collar 220 of the spider, as known in the art.

In order to facilitate proper actuation and performance of a brake system (not shown), first embodiment axle brake bracket 250 is utilized. Axle brake bracket 250 includes a cam shaft portion 252, an axle portion 254, and a brake chamber portion 256. Cam shaft portion 252, axle portion 254, and brake chamber portion 256 are individually manufactured and rigidly connected, generally by welding. By individually manufacturing each respective portion, manufacturing costs are reduced. Cam shaft portion 252 is generally C-shaped and is formed with a plurality of bolt openings 258. Bolt openings 258 each receive a fastener 262, such as a bolt, and a corresponding nut 264 to connect to cam tube bracket 207. Additionally, cam shaft portion 252 is formed with a cam tube opening 260, radially spaced from and axially aligned with thin-wall axle 202, to receive cam tube 214. Further, cam shaft portion 252 is formed with a curved elongated opening 266 to receive an anchor pin (not shown).

Cam shaft portion 252 is rigidly connected to axle portion 254, generally by welding, at an intersection 268. Axle portion 254 is generally U-shaped and partially surrounds axle 202. More specifically, axle portion 254 is formed with a curvature configured to seat on a top portion 205 of axle 202, as will be described below. Even more specifically, axle portion 254 partially surrounds axle 202 in a range from about 180 degrees to about 360 degrees. The range of partial surroundment of axle 202 by axle portion 254 allows for the axle portion to pull apart and snap onto the axle or slide onto the axle providing a generally gap-free connection. It is noted that depending on the application, the robustness of the material of first embodiment axle brake bracket 250 can be varied. Additionally, axle portion 254 includes a pair of windows 270A,B that are generally similar in size that facilitate the rigid connection of axle brake bracket 250 of the present invention to axle 202, near the horizontal neutral axis of the axle, as will be described below.

Axle portion 254 is connected to brake chamber portion 256, generally by welding, at intersection 272. Brake chamber portion 256 includes a pair of sidewalls 274 and a base portion 276 so that the brake chamber portion forms a generally U-shape. Sidewalls 274 include a pair of wings 278 that each extend perpendicularly from its respective sidewall and spaced from base portion 276. Each wing 278 is formed with three openings 280 to facilitate connecting to a brake chamber of a brake system (not shown). Additionally, base portion 276 is formed with an elongated opening 282. Opening 282 allows for clearance for a pushrod (not shown) to be disposed through.

In addition to axle portion 254 pulling apart and snapping or sliding onto axle 202, the axle portion includes pair of windows 270A,B to further facilitate the connection to the axle. The window weld is a continuous weld that starts and stops at the same point within windows 270A,B. In this manner, windows 270A,B are welded to axle 202 by utilizing a continuous window weld connection as indicated by CWW. In contrast, a line weld is a weld that begins at one point and ends at a separate point. At the beginning and end point of the line weld, each point is an area that is susceptible to stress, known as a stress riser. A stress riser is generally a point or area that is a weaker area in the metal as a result of the welding generally impacting the integrity of the metal. Because continuous window weld CWW does not have separate starting points and end pints, stress risers are generally reduced and/or eliminated. In this manner, it is typically understood that a continuous weld is stronger than a line weld because of the continuity of the weld. Therefore, the use of continuous window weld CWW at window 270A,B reduces and/or eliminates stress risers that are typically associated with line welds.

To further reduce the stress risers upon axle 202, the location of the window welds are located on the axle in an area that is generally considered a lower stress area, front and rear quadrants of the axle, or near the horizontal neutral axis of the axle. Window welds CWW within windows 270A,B and the location of the welds reduce the stress risers that facilitate the use of a thin-wall axle 202 which reduces the weight and reduces the cost. Thin-wall axle 202 is generally considered to be an axle with a wall thickness ranging from about 0.285 inches to about 0.45 inches.

First embodiment axle brake bracket 250 is a lightweight bracket that utilizes a pulled apart and snapped-on connection or slides onto axle 202 to create a generally gap-free connection to the axle, and further utilizes continuous window weld CWW within each of windows 270A,B to rigidly connect the axle brake bracket to the axle. In this manner, line welds are not utilized and stress risers associated with line welds are reduced as a result of the utilization of continuous window welds upon axle 202. The utilization of continuous window welds allows for thin-wall axle 202 to be employed thus reducing weight and operating costs.

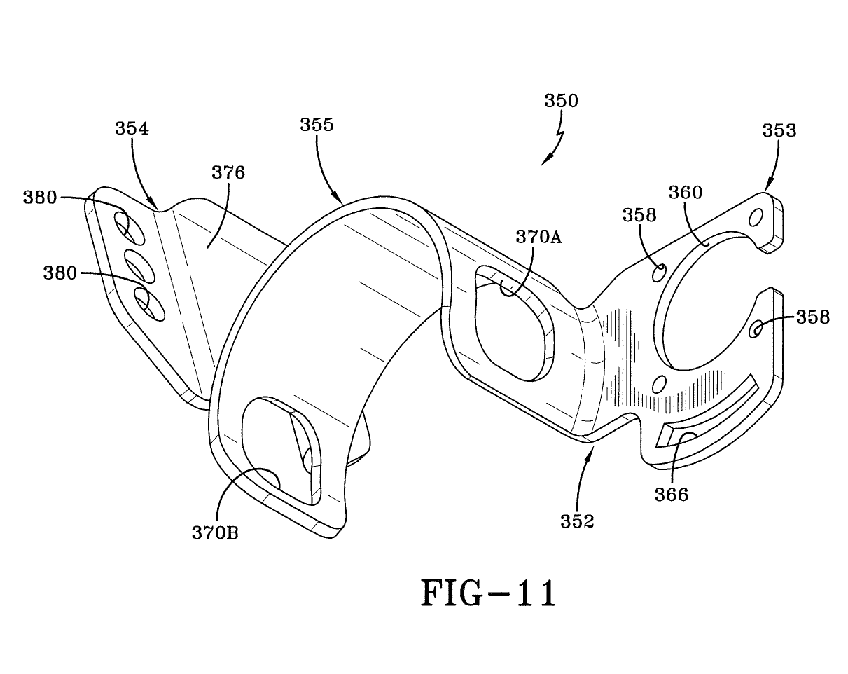

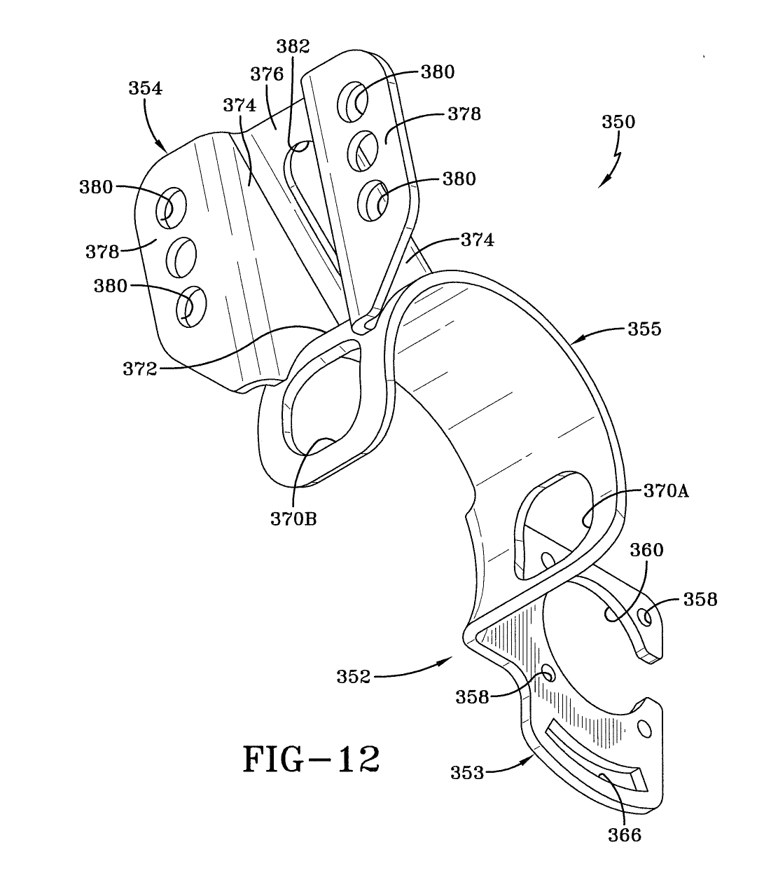

Turning to FIGS. 11-12, a second embodiment axle brake bracket of the present invention is indicated at 350. Second embodiment axle brake bracket 350 includes an axle/cam shaft portion 352 and a brake chamber portion 354 forming a two-piece axle brake bracket. Axle/cam shaft portion 352 includes a cam shaft portion 353 and an axle portion 355, and is formed as a single-piece to be connected to brake chamber portion 354. The two-piece construction helps to simplify manufacturing of the axle brake bracket 350 and reduces the number of connection points, thereby reducing stress risers that may occur on the axle brake bracket. More particularly, by integrally forming cam shaft portion 353 and axle portion 355 into axle/cam shaft portion 352, the possibility for stress risers to form in axle brake bracket 350 is reduced. A stress riser is generally a point or area that is weaker area in the metal as a result of the welding generally impacting the integrity of the metal. By reducing the number of welds, stress risers are reduced by integrally forming axle/cam shaft portion 352. Cam shaft portion 353 is generally C-shaped and is formed with a plurality of bolt openings 358. Each bolt opening 358 receives a fastener (not shown), such as a bolt, and a corresponding nut (not shown) to connect to cam tube bracket 207. Additionally, cam shaft portion 353 is formed with a cam tube opening 360, radially spaced from and axially aligned with thin-wall axle 202, to receive cam tube 214. Further, cam shaft portion 353 is formed with a curved elongated opening 366 to receive an anchor pin (not shown).

Cam shaft portion 353 is integrally formed with axle portion 355 to form axle/cam shaft portion 352. Axle portion 355 is generally U-shaped and partially surrounds axle 202. More specifically, axle portion 355 is formed with a curvature that is configured to seat on a top portion 205 of axle 202, as will be described below. Even more specifically, axle portion 355 partially surrounds axle 202 in a range from about 180 degrees to about 360 degrees. The range of partial surroundment of axle 202 by axle portion 355 allows for the axle portion to pull apart and snap onto the axle or slides onto the axle providing a generally gap-free connection. It is noted that depending on the application, the robustness of the material of second embodiment axle brake bracket 350 can be varied. Additionally, axle portion 355 includes a pair of windows 370A,B that facilitate the rigid connection of axle brake bracket 350 of the present invention to axle 202, near the horizontal neutral axis of the axle, as will be described below.

Axle portion 355 is rigidly connected to brake chamber portion 354, generally by welding, at an intersection 372. Brake chamber portion 354 includes a pair of sidewalls 374 and a base portion 376 so that the brake chamber portion forms a generally U-shape. Sidewalls 374 include a pair of wings 378 that each extend perpendicularly from its respective sidewall and spaced from base portion 376. Each wing 378 is formed with three openings 380 to facilitate connecting to a brake chamber of a brake system (not shown). Additionally, base portion 376 is formed with an elongated opening 382. Opening 382 allows for clearance for a pushrod (not shown) to be disposed through.

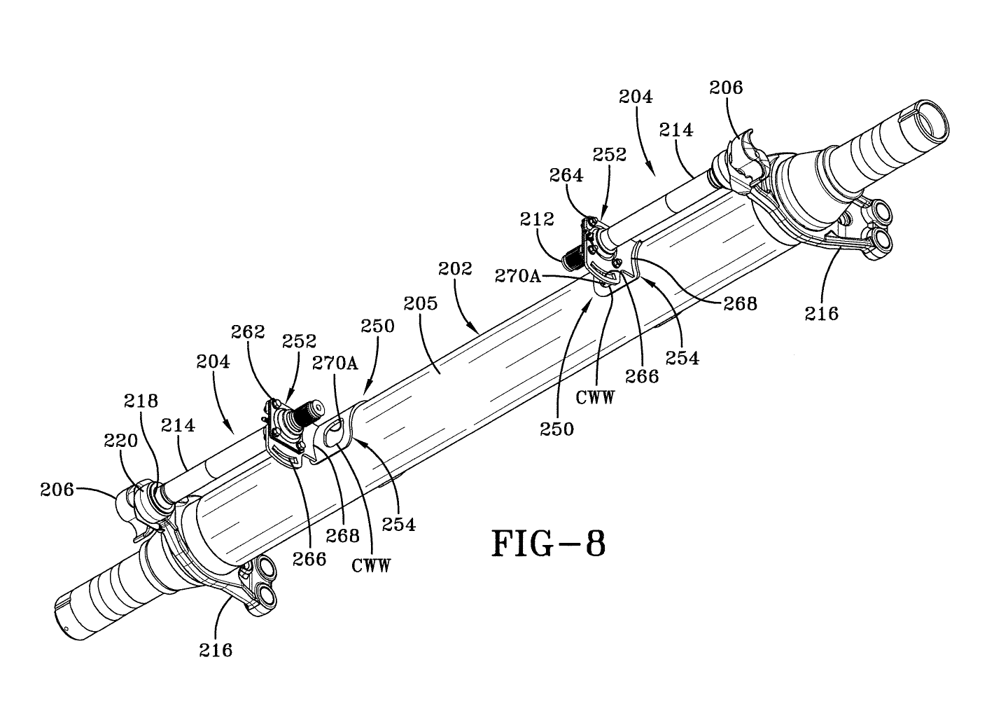

In addition to axle portion 355 pulling apart and snapping onto or sliding onto axle 202, the axle portion includes pair of windows 370A,B, that are continuously welded to the axle, similar to CWW (FIGS. 7-8), to further facilitate the connection to the axle. The window weld is a continuous weld that starts and stops at the same point within windows 370A,B. In this manner, windows 370A,B are welded to axle 202 by utilizing a continuous window weld connection. In contrast, a line weld is a weld that begins at one point and ends at a separate point. At the beginning and end point of the line weld, each point is an area that is susceptible to stress, known as a stress riser. A stress riser is generally a point or area that is a weaker area in the metal as a result of the welding generally impacting the integrity of the metal. Because continuous window weld does not have separate starting points and end points, stress risers are generally reduced and/or eliminated. In this manner, it is typically understood that a continuous weld is stronger than a line weld because of the continuity of the weld. Therefore, the use of continuous window weld at window 370A,B reduces and/or eliminates stress risers that are typically associated with line welds.

To further reduce the stress upon axle 202, the location of the window welds are located on the axle in an area that is generally considered a lower stress area of the axle, front and rear quadrants of the axle, or near the horizontal neutral axis of the axle. The window welds within windows 370A,B and the location of the welds reduce the stress risers that facilitate the use of thin-wall axle 202 which generally reduces the weight and cost. Thin-wall axle 202 is generally considered to be an axle with a wall thickness ranging from about 0.285 inches to about 0.45 inches. Second embodiment axle brake bracket 350 is a two-piece, lightweight bracket that utilizes a pulled apart and snapped-on connection or slides onto axle 202, and further utilizes a continuous window weld within each of windows 370A,B to rigidly connect the axle brake bracket to axle 202. In this manner, stress risers associated with line welds are reduced as a result of the utilization of continuous window welds upon axle 202 instead of line welds. Further, the two-piece structure reduces the number of welds in axle brake bracket 350, when compared to first embodiment axle brake bracket 250, potentially reducing the stress risers within the axle brake bracket. The utilization of continuous window welds allows for thin-wall axle 202 to be employed thus reducing weight and reducing operating costs.

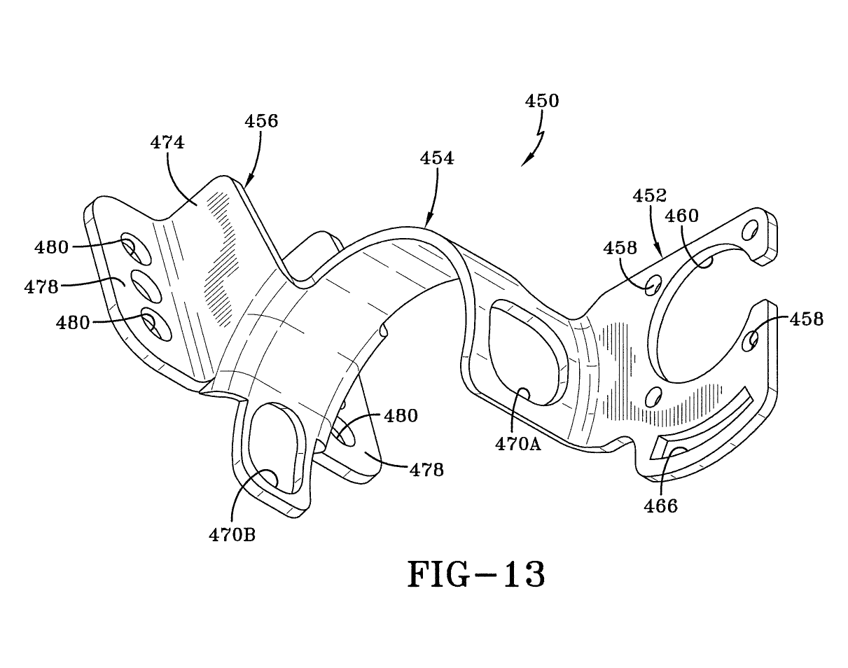

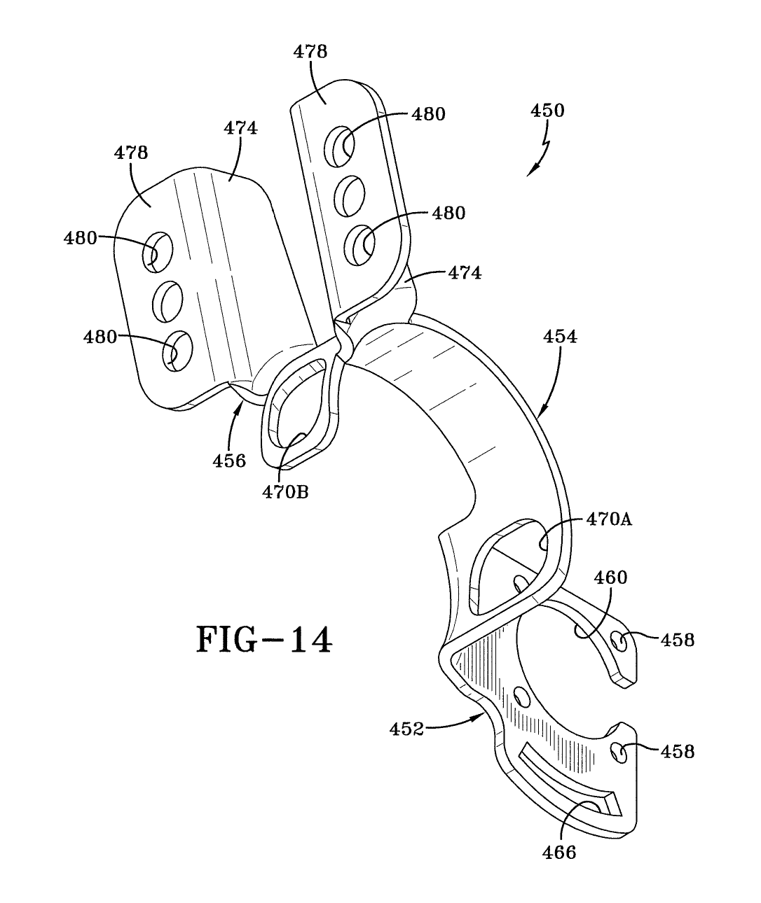

Turning to FIGS. 13-14, a third embodiment axle brake bracket of the present invention is shown at 450. Third embodiment axle brake bracket 450 is formed as a single-piece construction and includes a cam shaft portion 452, an axle portion 454, and a brake chamber portion 456. Cam shaft portion 452, axle portion 454, and brake chamber portion 456 are manufactured as a single-piece. By utilizing a single-piece construction for third embodiment axle brake bracket 450, the number of welds is reduced thus reducing stress risers that may occur on the axle brake bracket, when compared to first and second embodiment axle brake brackets 250, 350. A stress riser is generally a point or area that is a weaker area in the metal as a result of the welding generally impacting the integrity of the metal. More particularly, by integrally forming axle brake bracket 450, the possibility of stress risers forming in axle brake bracket 450 is reduced. Cam shaft portion 452 is generally C-shaped and is formed with a plurality of bolt openings 458. Bolt openings 458 each receive a fastener (not shown), such as a bolt, and a corresponding nut (not shown) to connect to cam tube bracket 207. Additionally, cam shaft portion 452 is formed with a cam tube opening 460, radially spaced from and axially aligned with thin-wall axle 202, to receive cam tube 214. Further, cam shaft portion 452 is formed with a curved elongated opening 466 to receive an anchor pin (not shown).

Axle portion 454 is generally U-shaped and partially surrounds axle 202. More specifically, axle portion 454 includes is formed with a curvature that is configured to seat on a top portion 205 of axle 202, as will be described below. Even more specifically, axle portion 454 partially surrounds axle 202 in a range from about 180 degrees to about 360 degrees. The range of partial surroundment of axle 202 by axle portion 454 allows for the axle portion to pull apart and snap onto the axle or slide onto the axle providing a generally gap-free connection. It is noted that depending on the application, the robustness of the material of third embodiment axle brake bracket 450 can be varied. Additionally, axle portion 454 includes a pair of windows 470A,B that facilitate the connection of axle brake bracket 450 of the present invention to axle 202, near the horizontal neutral axis of the axle, as will be described below.

Brake chamber portion 456 is formed with a pair of spaced apart sidewalls that extend from the rear end of axle portion 454. Sidewalls 474 include a pair of wings 478 that each extend perpendicularly from its respective sidewall. Each wing 478 is formed with three openings 480 to facilitate connecting to a brake chamber of a brake system (not shown).

Axle portion 454 includes pair of window 470A,B to further facilitate the connection to the axle. More particularly, windows 470A,B are welded to axle 202 by utilizing a continuous window weld connection, similar to CWW (FIGS. 7-8). The window weld is a continuous weld that starts and stops at the same point within windows 470A,B. In this manner, windows 370A,B are welded to axle 202 by utilizing a continuous window weld connection. In contrast, a line weld is a weld that begins at one point and ends at a separate point. At the beginning and end point of the line weld, each point is an area that is susceptible to stress, known as a stress riser. A stress riser is generally a point or area that is a weaker area in the metal as a result of the welding generally impacting the integrity of the metal. Because continuous window weld does not have separate starting points and end points, stress risers are generally reduced and/or eliminated. In this manner, it is typically understood that a continuous weld is stronger than a line weld because of the continuity of the weld. Therefore, the use of continuous window weld at window 470A,B reduces and/or eliminates stress risers that are typically associated with line welds.

To further reduce the stress upon axle 202, the location of the window welds are located on the axle in an area that is generally considered a lower stress area of the axle, front and rear quadrants of the axle, or near the horizontal neutral axis of the axle. The window welds within windows 470A,B and the location of the welds upon axle 202 reduce the stress risers associated with line welds and enable the use of the thin-wall axle which generally reduces the weight and cost. Thin-wall axle 202 is generally considered to be an axle with a wall thickness ranging from about 0.285 inches to about 0.45 inches.

Third embodiment axle brake bracket 450 is a single-piece, lightweight bracket that utilizes a pulled apart and snapped-on connection or slides onto axle 202 to create a generally gap-free connection to the axle, and further utilizes a continuous window weld within each of windows 470A,B to rigidly connect the axle brake bracket to thin-wall axle 202. In this manner, stress risers associated with line welds are reduced as a result of the utilization of continuous window welds upon axle 202. Further, the single-piece construction reduces the number of welds in the axle brake bracket 450 reducing the potential stress risers within the bracket. The utilization of continuous window welds allows for thin-wall axle 202 to be employed thus reducing weight and reducing operating costs.

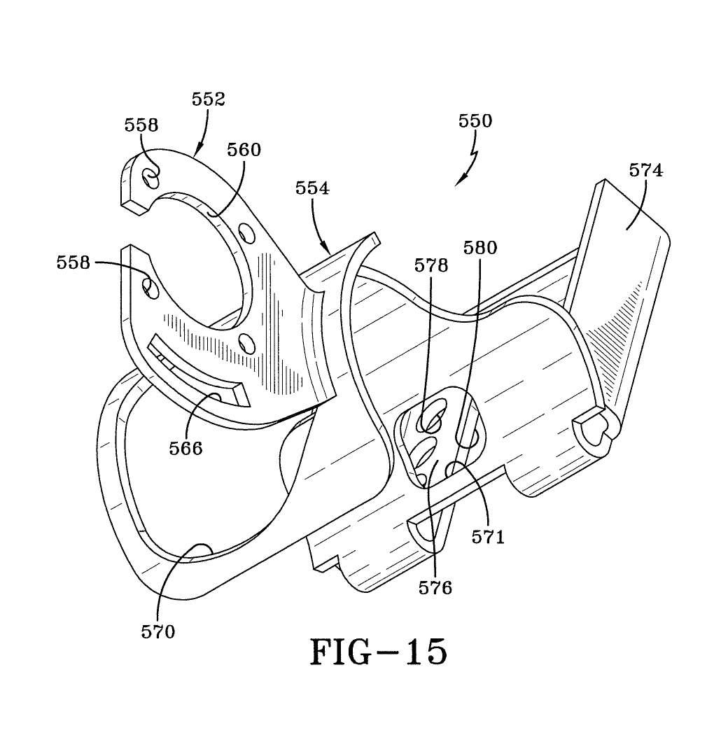

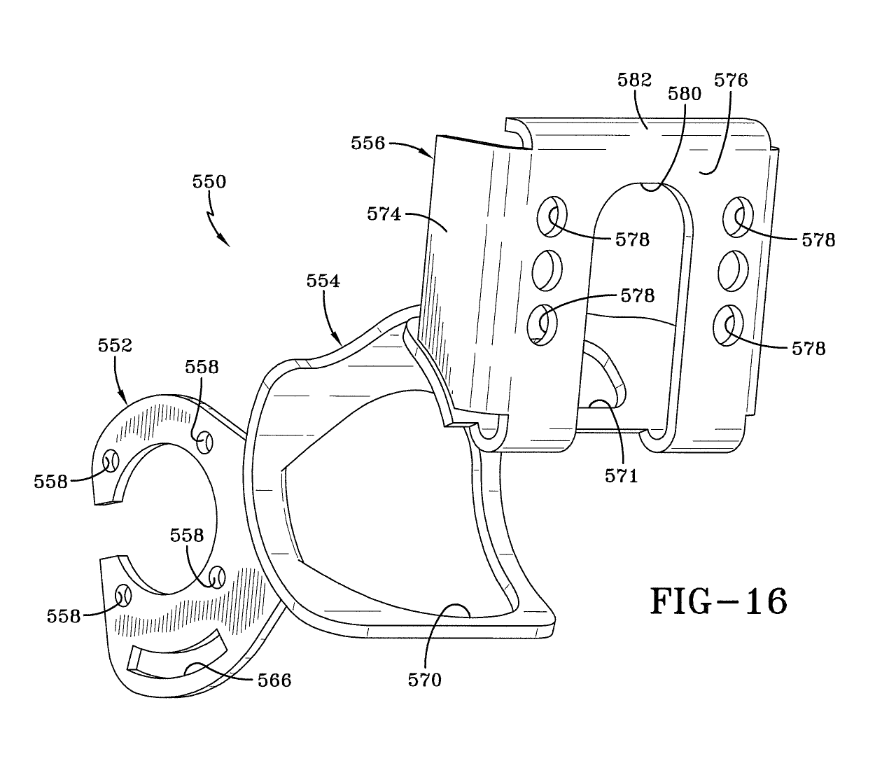

Turning to FIGS. 15-16, a fourth embodiment axle brake bracket of the present invention is shown at 550. Fourth embodiment axle brake bracket 550 includes a cam shaft portion 552, an axle portion 554, and a brake chamber portion 556 formed as a single-piece. By utilizing a single-piece construction for fourth embodiment axle brake bracket 550, connection areas are minimized maintaining the integrity of the axle brake bracket. Cam shaft portion 552 is generally C-shaped and is formed with a plurality of bolt openings 558. Bolt openings 558 each receive a fastener (not shown), such as a bolt, and a corresponding nut (not shown) to connect to cam tube bracket 207. Additionally, cam shaft portion 552 is formed with a cam tube opening 560, radially spaced from and axially aligned with thin-wall axle 202, to receive cam tube 214. Further, cam shaft portion 552 is formed with a curved elongated opening 566 to receive an anchor pin (not shown).

Axle portion 554 is generally saddle-shaped and partially surrounds axle 202. Axle portion 554 is formed with a saddle-shaped curvature that is configured to seat on top portion 205 of axle 202, as will be described below. More specifically, axle portion 554 partially surrounds axle 202 in a range from about 180 degrees to about 360 degrees. The range of partial surroundment of axle 202 by axle portion 554 allows for the axle portion to pull apart and snap onto the axle or slide onto the axle providing a generally gap-free connection. It is noted that depending on the application, the robustness of the material of fourth embodiment axle brake bracket 550 can be varied. Additionally, axle portion 554 includes pair of windows 570,571 that facilitate the rigid connection of axle brake bracket 550 of the present invention to axle 202, near the horizontal neutral axis of the axle, as will be described below. Windows 570, 571 differ in size and/or shape to reduce the potential stress risers upon rigid connection to axle 202. Also, windows 570, 571 allow for different mounting configurations of brake chamber (not shown) and/or cam shaft (not shown). Additionally, window 570 is created when cam shaft portion 552 is manufactured from the same piece of metal. More particularly, cam shaft portion 552 is stamped from the material thus creating window 570. In this manner, material waste is minimized thus reducing overall manufacturing cost of axle brake bracket 550.

Brake chamber portion 556 is formed with a pair of spaced apart sidewalls 574 and a base portion 576, so that the brake chamber portion is generally U-shaped. Base portion 576 includes a plurality of openings 578, an elongated opening 580, and a tab 582 that facilitate the connection a brake chamber of the brake system (not shown). Tab 582 provides stiffness to fourth embodiment axle brake bracket 550.

Axle portion 554 includes pair of windows 570, 571 that are continuously welded to axle 202, similar to CWW (FIG. 7-8), to further facilitate the connection to the axle. The window weld is a continuous weld that starts and stops at the same point within windows 570, 571. In this manner, windows 570, 571 are welded to axle 202 by utilizing a continuous window weld. In contrast, a line weld is a weld that begins at one point and ends at a separate point. At the beginning and end point of the line weld, each point is an area that is susceptible to stress, known as a stress riser. A stress riser is generally a point or area that is a weaker area in the metal as a result of the welding generally impacting the integrity of the metal. Because continuous window weld does not have separate starting points and end points, stress risers are generally reduced and/or eliminated. In this manner, it is typically understood that a continuous weld is stronger than a line weld because of the continuity of the weld. Therefore, the use of continuous window weld at windows 570, 571 reduces and/or eliminates stress risers that are typically associated with line welds.

To further reduce the stress upon axle 202, the location of the window welds are located on the axle in an area that is considered a lower stress area of the axle, generally front and rear quadrants of the axle, or near the horizontal neutral axis of the axle. The window welds within windows 570, 571 and the location of the welds upon axle 202 generally reduce the stress risers that enable the use of thin-wall axle 202 which generally reduces the weight and reduces the cost. Thin-wall axle 202 is generally considered to be an axle with a wall thickness ranging from about 0.285 inches to about 0.45 inches.

Fourth embodiment axle brake bracket 550 is a single-piece, lightweight bracket that utilizes a pulled apart and snapped-on connection or slides onto axle 202 to create a generally gap-free connection to the axle, and further utilizes continuous window welds within each of varying size windows 570, 571, when compared to first, second, and third embodiment axle brake brackets 250, 350, 450, to rigidly connect the axle brake bracket to thin-wall axle 202. In this manner, axle brake bracket 550 is secured and stress risers associated with line welds are reduced as a result of the continuous window welds. Further, the single-piece construction reduces the number of welds in the axle brake bracket 550 reducing the potential stress risers within the bracket. The utilization of continuous window welds allows for thin-wall axle 202 to be used thus reducing weight and reducing operating costs.

It is contemplated that other means for rigidly attaching axle brake brackets 250, 350, 450 and 550, in addition to window welds may be utilized. For example, dimples or depressions may be utilized as discussed and shown in U.S. application Ser. No. 13/249,420, which is assigned to the same assignee as the present invention, Hendrickson USA, L.L.C. The utilization of continuous window welds and an at least one depression allows for thin-wall axle 202 to be used thus reducing weight and reducing operating costs.

Axles typically are hollow, which desirably reduces the amount of material used to manufacture an axle, thereby decreasing manufacturing costs, and also reduces axle weight, thereby reducing vehicle fuel consumption and costs associated with operation of the vehicle. As a result, it is desirable to use an axle with the thinnest possible wall to optimize the material and weight savings. The use of line welds in the prior art to rigidly connect cam shaft assembly mounting bracket to the axle undesirably increases the thickness of the axle.

As a result, axle brake brackets 250, 350, 450, and 550 of the present invention provide a construction that eliminates line welds, reduces stress risers that are associated with line welds, and enables thin-wall axle 202 to be employed. Additionally, thin-wall axle 202 reduces weight and decreases cost. More particularly, axle brake brackets 250, 350, 450, and 550 utilize window weld CWW to reduce and/or eliminate stress risers associated with line welds. First and second embodiment axle brake brackets 250, 350 utilize multiple-piece construction, while third and fourth embodiment axle brake brackets 450, 550 utilize single-piece construction.

It is to be understood that the above described structure of an axle brake bracket 250, 350, 450, and 550 of the present invention may be altered or rearranged, or certain components omitted or added, without affecting the overall concept or operation of the present invention. For example, axle portion 254, 355, 454, and 554 may include different shapes and degree of surrounding of axle 202, including completely surrounding the axle or surrounding the axle less than 180 degrees. In addition, axle brake bracket 250, 350, 450, and 550 may include any number of individual pieces to form the axle brake bracket. Further, axle brake bracket 250, 350, 450, and 550 may be constructed of other materials without affecting the overall concept or operation of the invention. Even further, any number of openings 280, 282, 380, 382, 480, 578 and 580 may be utilized and other shapes or configurations may be utilized without affecting the overall concept or operation of the present invention. Additionally, any number of windows 270A,B, 370A,B, 470A,B, 570, and 571 may be utilized with corresponding window welds. Further, cam shaft portion 252, 353, 452, and 552 axle portion 254, 355, 454, 554 and brake chamber mounting portion 256, 354, 456, 556 may include different shapes. It is also contemplated that tab 582 may be omitted from fourth embodiment axle brake bracket 550 without affecting the overall concept or operation of the present invention. Additionally, the size and/or shape of windows 270A,B, 370A,B, 470A,B, 570, and 571 may be altered without affecting the overall concept or operation of the invention.

As described above, it is also to be understood that the above-described axle brake bracket of the present invention 250, 350, 450, 550, may be employed in conjunction with any type of spring axle/suspension system or air-ride axle/suspension system without affecting the overall concept or operation of the invention. In addition, the invention applies to various types of frames used for heavy-duty vehicles, including primary frames that do not support a subframe and primary frames and/or floor structures that do support a movable or non-movable subframe. Further, the invention applies to axle/suspension systems with any number of axles 202 without affecting the overall concept or operation of the present invention. In addition, other types of cam tube assemblies may be utilized without affecting the overall concept or operation of the present invention.

Accordingly, the axle brake bracket for thin-wall axle of the present invention is simplified, provides an effective, safe, inexpensive and efficient structure and method which achieves all the enumerated objectives, provides for eliminating difficulties encountered with prior art axle brake brackets, and solves problems and obtains new results in the art.

In the foregoing description, certain terms have been used for brevity, clearness and understanding; but no unnecessary limitations are to be implied therefrom beyond the requirements of the prior art, because such terms are used for descriptive purposes and are intended to be broadly construed.

Moreover, the description and illustration of the invention is by way of example, and the scope of the invention is not limited to the exact details shown or described.

Having now described the features, discoveries and principles of the invention, the manner in which the axle brake bracket for thin-wall axles of the present invention is used and installed, the characteristics of the construction, arrangement and method steps, and the advantageous, new and useful results obtained; the new and useful structures, devices, elements, arrangements, process, parts and combinations are set forth in the appended claims.

What is claimed is:

1. An axle brake bracket for an axle/suspension system, said bracket securing a cam shaft assembly and a brake air chamber to an axle of the axle/suspension system, said bracket comprising:
an axle portion configured to seat on said axle;
at least one window formed in said axle portion;
said axle portion being rigidly connected to said axle by a continuous weld formed in said at least one window; and
said axle brake bracket being free of a line weld between said axle portion and said axle.

2. The axle brake bracket for axle/suspension system of claim 1, wherein said axle portion includes a generally U-shape.

3. The axle brake bracket for axle/suspension system of claim 1, wherein said at least one window is generally circular-shaped.

4. The axle brake bracket for axle/suspension system of claim 1, wherein said at least one window is located on a front quadrant of said axle.

5. The axle brake bracket for axle/suspension system of claim 1, wherein said at least one window is located on a rear quadrant of said axle.

6. The axle brake bracket for axle/suspension system of claim 1, wherein said at least one window comprises a pair of windows.

7. The axle brake bracket for axle/suspension system of claim 6, wherein said pair of windows are generally similar shaped.

8. The axle brake bracket for axle/suspension system of claim 6, wherein said pair of windows are different sizes.

9. The axle brake bracket for axle/suspension system of claim 1, wherein said axle brake bracket further comprises a cam shaft portion and a brake chamber portion.

10. The axle brake bracket for axle/suspension system of claim 9, wherein said cam shaft portion and said axle portion are integrally formed as a single piece.

11. The axle brake bracket for axle/suspension system of claim 9, wherein said cam shaft portion, said brake chamber portion and said axle portion are integrally formed as a single piece.

12. The axle brake bracket for axle/suspension system of claim 1, wherein said axle portion extends about three-quarters of a circumference of said axle.

13. The axle brake bracket for axle/suspension system of claim 1, wherein said axle portion extends about one-half of a circumference of said axle.

14. The axle brake bracket for axle/suspension system of claim 1, wherein said axle portion extends about less than 360 degrees of a circumference of said axle.

15. The axle brake bracket for axle/suspension system of claim 1, wherein said axle portion further includes at least one depression.

16. The axle brake bracket for axle/suspension system of claim 1, wherein said axle/suspension system is a mechanical spring axle/suspension system.
